(19) United States
(12) Patent Application Publication
(10) Pub. No.: US 2025/0364644 A1
(43) Pub. Date: Nov. 27, 2025

(54) POWER STORAGE DEVICE, POWER STORAGE DEVICE CASE, AND EXTERIOR MATERIAL HAVING OPENING PORTION FOR POWER STORAGE DEVICE

(71) Applicant: DNP HIGH-PERFORMANCE MATERIALS HIKONE CO., LTD., Hikone-shi (JP)

(72) Inventors: Daisuke NAKAJIMA, Hikone-shi (JP); Terutoshi KUMAKI, Hikone-shi (JP)

(73) Assignee: DNP HIGH-PERFORMANCE MATERIALS HIKONE CO., LTD., Hikone-shi (JP)

(21) Appl. No.: 19/294,312

(22) Filed: Aug. 8, 2025

Related U.S. Application Data
(63) Continuation of application No. PCT/JP2024/004652, filed on Feb. 9, 2024.

(30) Foreign Application Priority Data
Feb. 10, 2023 (JP) 2023-019416

(51) Int. Cl. H01M 50/133; H01M 10/613; H01M 10/647; H01M 10/653; H01M 50/105; H01M 50/119; H01M 50/121; H01M 50/129; H01M 50/186; H01M 50/193

(52) U.S. Cl. CPC H01M 50/133; H01M 10/613; H01M 10/647; H01M 10/653; H01M 50/105; H01M 50/119; H01M 50/121; H01M 50/129; H01M 50/186; H01M 50/193

(57) ABSTRACT

An exterior material having an opening portion for a power storage device includes a base layer, a metal foil layer, a heat-resistant gas barrier layer, and a sealant layer laminated in this order. An opening portion is formed in the sealant layer to expose the gas barrier layer. The exterior material is configured such that ΔT=(|T0−T1|/T0)×100≤10%, where T0 is the thickness of the gas barrier layer in an opening-portion-side standard region defined as a region extending from 1 mm to 1.5 mm toward the opening portion from the edge portion of the opening portion, and T1 is the thickness of the same layer in an opening-portion-side evaluation region defined as a region extending from 0 mm to 0.5 mm toward the opening portion from the edge portion of the opening portion.

### CROSS-REFERENCE TO RELATED APPLICATIONS

The present application is a continuation application of International Application No. PCT/JP2024/004652, filed on Feb. 9, 2024, which claims priority to Japanese Patent Application No. 2023-019416 filed on Feb. 10, 2023, the contents of which are incorporated herein by reference in its entirety.

### BACKGROUND OF THE INVENTION

### Field of the Invention

The present disclosure relates to a power storage device, such as an all-solid-state battery, which is used as a high-power battery for vehicle applications, a battery for portable devices such as mobile electronic equipment, or a battery for storing regenerative energy, and further relates to a power storage device case and an exterior material having an opening portion for a power storage device, used in such a power storage device.

### Description of the Related Art

In conventionally widely used lithium-ion secondary batteries, since a liquid electrolyte is used, there has been a risk that the separator may be damaged due to liquid leakage or the formation of dendrites. In some cases, this may result in ignition or the like due to short circuiting.

In contrast, an all-solid-state battery is a battery that uses a solid electrolyte, so liquid leakage and the formation of dendrites do not occur, nor is the separator damaged. Therefore, concerns such as ignition due to separator damage are no longer present, and such batteries have attracted considerable attention from the viewpoint of safety and the like.

The typical all-solid-state battery is constructed such that an all-solid-state battery cell including an electrode active material, a solid electrolyte, and other components are sealed inside an exterior material serving as a casing. In this all-solid-state battery, as research on solid electrolytes progresses, performance requirements for the exterior material that differ from those for exterior materials of conventional batteries using liquid electrolytes have gradually emerged, and various exterior materials have been proposed to satisfy performance requirements for all-solid-state batteries.

An exterior material for an all-solid-state battery has, as a basic structure, a metal foil layer and a heat-fusible layer (sealant layer) laminated on the inner side of the metal foil layer and is configured to seal an all-solid-state battery cell by heat-fusing the sealant layer.

For example, the exterior material for an all-solid-state battery disclosed in Patent Document 1 includes a protective film interposed between a metal foil layer and a sealant layer, and a sealant layer having high hydrogen sulfide gas permeability is used. Furthermore, in the exterior material for an all-solid-state battery disclosed in Patent Document 2, a sealant layer having low hydrogen sulfide gas permeability is used. In addition, in the exterior material for an all-solid-state battery disclosed in Patent Document 3, a sealant layer that absorbs gas is used. Further, in the exterior material for an all-solid-state battery disclosed in Patent Document 4, a vapor-deposited film layer is laminated on the inner surface of the sealant layer.

### PRIOR ART DOCUMENTS

### Patent Documents

Patent Document 1: Japanese Patent No. 6777276
Patent Document 2: Japanese Patent No. 6747636
Patent Document 3: Japanese Unexamined Patent Application Publication No. 2020-187855
Patent Document 4: Japanese Unexamined Patent Application Publication No. 2020-187835

### SUMMARY OF THE INVENTION

### Problems to Be Solved by the Invention

However, the conventional all-solid-state batteries have a problem in that gases, such as hydrogen sulfide gas, generated by a reaction between the solid electrolyte and moisture, may leak.

On the other hand, in all-solid-state batteries, the exchange of electrons (ions) occurs through the solid electrolyte during charging and discharging. Therefore, compared with liquid electrolytes, all-solid-state batteries tend to exhibit higher internal resistance and increased heat generation. However, it is considered that the performance of all-solid-state batteries is not affected even in high-temperature environments. As a result, including Patent Documents 1 to 4, countermeasures for high temperatures (cooling performance) have not been discussed. Nevertheless, as battery technologies continue to evolve toward higher output and capacity, it is fully anticipated that there will be a future demand for improved cooling performance even in all-solid-state batteries.

The above describes the problems in all-solid-state batteries. However, similar problems may also arise in other power storage devices.

Preferred embodiments of the present disclosure have been made in view of the above and/or other problems in the related technologies. The preferred embodiments of the present disclosure are capable of significantly improving existing methods and/or devices.

The present disclosure has been made in view of the above problems. An object of the present disclosure is to provide a power storage device, a power storage device case, and an exterior material having an opening portion for a power storage device that are configured to prevent the leakage of gases, such as hydrogen sulfide gas, while ensuring sufficient cooling performance.

Other objects and advantages of the present disclosure will become apparent from the following preferred embodiments.

### Means for Solving the Problems

In order to solve the above problems, the present disclosure provides the following means.
[1] An exterior material having an opening portion for a power storage device, comprising:
   a base layer made of resin;
   a metal foil layer laminated on an inner surface side of the base layer;
   a heat-resistant gas barrier layer made of resin and laminated on an inner surface side of the metal foil layer; and
   a sealant layer made of resin and laminated on an inner surface side of the heat-resistant gas barrier layer,
   wherein an opening portion is formed in the sealant layer of the exterior material to expose the heat-resistant gas barrier layer on an inner surface of the exterior material, and
   wherein the exterior material is configured such that ΔT satisfies the following expression:

$$Δ T = ( \vert T 0 - T 1 \vert / T 0 ) \times 100 ≦ 10 \% ,$$

where
T0 is a thickness of the heat-resistant gas barrier layer in an opening-portion-side standard region, the opening-portion-side standard region being defined as a region extending from 1 mm to 1.5 mm toward the opening portion from an edge portion of the opening portion,
T1 is a thickness of the heat-resistant gas barrier layer in an opening-portion-side evaluation region, the opening-portion-side evaluation region being defined as a region extending from 0 mm to 0.5 mm toward the opening portion from the edge portion of the opening portion, and
ΔT is a thickness change ratio of the heat-resistant gas barrier layer in the opening-portion-side evaluation region, as defined by the above expression.
[2] The exterior material having an opening portion for a power storage device, as recited in the above-described Item [1],
   wherein the exterior material is configured such that ΔSa satisfies the following expression:

$$Δ Sa = \vert Sa 1 - Sa 0 \vert ≦ 2 μ m ,$$

where
Sa1 is an arithmetical mean height of the heat-resistant gas barrier layer in the opening-portion-side evaluation region,
Sa0 is an arithmetical mean height of the heat-resistant gas barrier layer in the opening-portion-side standard region, and
ΔSa is an absolute value of a difference between the arithmetical mean height of the heat-resistant gas barrier layer in the opening-portion-side evaluation region and the arithmetical mean height of the heat-resistant gas barrier layer in the opening-portion-side standard region, as defined by the above expression.
[3] The exterior material having an opening portion for a power storage device, as recited in the above-described Item [1] or [2],
   wherein the exterior material is configured such that ΔH satisfies the following expression:

$$Δ H = ( \vert H 0 - H 1 \vert / H 0 ) \times 100 ≦ 10 \% ,$$

where
H0 is a thickness of the sealant layer in a non-opening-portion-side standard region, the non-opening-portion-side standard region being defined as a region extending from 1 mm to 1.5 mm toward the non-opening portion from the edge portion of the opening portion,
H1 is a thickness of the sealant layer in a non-opening-portion-side evaluation region, the non-opening-portion-side evaluation region being defined as a region extending from 0 mm to 0.5 mm toward the non-opening portion from the edge portion of the opening portion, and
ΔH is a thickness change ratio of the sealant layer in the non-opening-portion-side evaluation region, as defined by the above expression.
[4] An exterior material having an opening portion for a power storage device, comprising:
   a base layer made of resin;
   a metal foil layer laminated on an inner surface side of the base layer;
   a heat-resistant gas barrier layer made of resin and laminated on an inner surface side of the metal foil layer; and
   a sealant layer made of resin and laminated on an inner surface side of the heat-resistant gas barrier layer,
   wherein an opening portion is formed in the sealant layer material to expose the heat-resistant gas barrier layer on an inner surface of the exterior material, and
   wherein the exterior material is configured such that ΔSa satisfies the following expression:

$$Δ Sa = \vert Sa 1 - Sa 0 \vert ≦ 2 μ m ,$$

where
Sa1 is an arithmetical mean height of the heat-resistant gas barrier layer in an opening-portion-side evaluation region, the opening-portion-side evaluation region being defined as a region extending from 0 mm to 0.5 mm toward the opening portion from an edge portion of the opening portion,
Sa0 is an arithmetical mean height of the heat-resistant gas barrier layer in an opening-portion-side standard region, the opening-portion-side standard region being defined as a region extending from 1 mm to 1.5 mm toward the opening portion from an edge portion of the opening portion, and
ΔSa is an absolute value of a difference between the arithmetical mean height of the heat-resistant gas barrier layer in the opening-portion-side evaluation region and the arithmetical mean height of the heat-resistant gas barrier layer in the opening-portion-side standard region, as defined by the above expression.
[5] The exterior material having an opening portion for a power storage device, as recited in the above-described Item [4],
   wherein the exterior material is configured such that ΔH satisfies the following expression:

$$Δ H = ( \vert H 0 - H 1 \vert / H 0 ) \times 100 ≦ 10 \% ,$$

where
H0 is a thickness of the sealant layer in a non-opening-portion-side standard region, the non-opening-portion-side standard region being defined as a region extending from 1 mm to 1.5 mm toward the non-opening portion from an edge portion of the opening portion,
H1 is a thickness of the sealant layer in a non-opening-portion-side evaluation region, the non-opening-portion-side evaluation region being defined as a region extending from 0 mm to 0.5 mm toward the non-opening portion from the edge portion of the opening portion, and
ΔH is a thickness change ratio of the sealant layer in the non-opening-portion-side evaluation region as defined by the above expression.
[6] An exterior material having an opening portion for a power storage device, comprising:
   a base layer made of resin;
   a metal foil layer laminated on an inner surface side of the base layer;
   a heat-resistant gas barrier layer made of resin and laminated on an inner surface side of the metal foil layer; and
   a sealant layer made of resin and laminated on an inner surface side of the heat-resistant gas barrier layer,
   wherein an opening portion is provided in the sealant layer of the exterior material to expose the heat-resistant gas barrier layer on an inner surface of the exterior material,
   wherein the exterior material is configured such that ΔH satisfies the following expression:

$$Δ H = ( \vert H 0 - H 1 \vert / H 0 ) \times 100 ≦ 10 \% ,$$

where
H0 is a thickness of the sealant layer in a non-opening-portion-side standard region, the non-opening-portion-side standard region being defined as a region extending from 1 mm to 1.5 mm toward a non-opening portion from an edge portion of the opening portion,
H1 is a thickness of the sealant layer in a non-opening-portion-side evaluation region, the non-opening-portion-side evaluation region being defined as a region extending from 0 mm to 0.5 mm toward the non-opening portion from the edge portion of the opening portion, and
ΔH is a thickness change ratio of the sealant layer in the non-opening-portion-side evaluation region as defined by the above expression.
[7] A power storage device case comprising:
   the case body composed of the exterior material having an opening portion for a power storage device as recited in any one of the above-described Items [1] to [6],
   wherein the case body includes a recessed housing portion and a flange provided around an outer periphery of the housing portion, and
   wherein the opening portion is provided at a position corresponding to the housing portion.
[8] A power storage device comprising:
   the case body as recited in the above-described Item [7];
   a power storage device cell housed in a housing portion of the case body; and
   a sealing member heat-sealed to a flange of the case body while closing an opening of the housing portion.
[9] The power storage device as recited in the above-described Item [8],
   wherein the sealing member includes:
   a base layer made of resin;
   a metal foil layer laminated on an inner surface side of the base layer;
   a heat-resistant gas barrier layer laminated on an inner surface side of the metal foil layer; and
   a sealant layer laminated on an inner surface side of the heat-resistant gas barrier layer,
   wherein the opening portion is provided in the sealant layer to expose the gas barrier layer of the sealing member to the housing portion.
[10] A method for producing an exterior material having an opening portion for a power storage device, the exterior material including a base layer made of resin, a metal foil layer laminated on an inner surface side of the base layer, a heat-resistant gas barrier layer made of resin and laminated on an inner surface side of the metal foil layer, and a sealant layer made of resin and laminated on an inner surface side of the heat-resistant gas barrier layer,
   the method comprising:
   cutting an opening-portion-intended portion of the sealant layer with a punching blade to form the opening portion in the sealant layer to expose the heat-resistant gas barrier layer on an inner surface of the exterior material.

### Effects of the Invention

An exterior material having an opening portion for a power storage device as described in the above invention [1] includes a heat-resistant gas barrier layer between a metal foil layer and a sealant layer, and an opening portion is formed in the sealant layer. Since the opening portion has no sealant layer, heat generated from the power storage device cell is not blocked by the sealant layer but is efficiently transferred to the metal foil layer via the opening portion and the heat-resistant gas barrier layer. The heat is thus dissipated, thereby ensuring sufficient heat dissipation and cooling performance. Furthermore, in the present disclosure, the heat-resistant gas barrier layer is disposed on the inner surface side of the metal foil layer. Therefore, even if hydrogen sulfide gas or the like is generated due to a reaction between the solid electrolyte of the power storage device cell and moisture in the outside air, leakage of the gas can be reliably prevented by the heat-resistant gas barrier layer. In addition, since the thickness change ratio ΔT of the heat-resistant gas barrier layer near the edge of the opening portion is 10% or less, no locally thinned areas occur in the heat-resistant gas barrier layer, even when a region corresponding to the opening portion is deformed during forming. As a result, defects such as pinholes and cracks can be suppressed, thereby improving moldability and electrical insulation.

According to the exterior material having an opening portion for a power storage device as described in the above invention [2], since the difference ΔSa in arithmetical mean height of the heat-resistant gas barrier layer near the edge portion of the opening portion is 2 μm or less, the variation is sufficiently small. As a result, when a power storage device is manufactured by sealing a power storage device cell with this exterior material, the cell comes into sufficiently close contact with the heat-resistant gas barrier layer, thereby further improving cooling performance and heat dissipation.

According to the exterior material having an opening portion for a power storage device as described in the above invention [3], the thickness change ratio ΔH of the sealant layer near the edge portion of the opening portion is 10% or less, indicating that the thickness change ratio ΔH is small. Therefore, pressure from a pressing die during a forming process is applied uniformly across the entire sealant layer near the edge portion of the opening portion, thereby preventing the formation of wrinkles and enabling a molded article with a good appearance.

According to the exterior material having an opening portion for a power storage device as described in the above invention [4], in the same manner as in the invention [1], sufficient heat dissipation and cooling performance can be ensured, and gas leakage can be reliably prevented. Further, in the same manner as in the invention [2], the power storage device cell comes into sufficiently close contact with the heat-resistant gas barrier layer, thereby enabling further improvement in cooling and heat dissipation performance.

According to the exterior material having an opening portion for a power storage device as described in the above invention [5], in the same manner as in the invention [3], a molded article with a good appearance can be formed.

According to the exterior material having an opening portion for a power storage device as described in the above invention [6], in the same manner as in the invention [1], sufficient heat dissipation and cooling performance can be ensured, and gas leakage can be reliably prevented. Further, in the same manner as in the invention [3], the power storage device cell comes into sufficiently close contact with the heat-resistant gas barrier layer, thereby enabling further improvement in cooling and heat dissipation performance.

According to the power storage device case as described in the above invention [7], since it is manufactured using the exterior material having an opening portion of the above invention, the same effects as described above can be obtained.

According to the power storage device as described in the above invention [8], since it is manufactured using the exterior material having an opening portion of the above invention, the same effects as described above can be obtained.

According to the power storage device as described in the above invention [9], since an opening portion is also formed in the sealant layer of the sealing member, heat dissipation performance and cooling can be further improved.

According to the manufacturing method as described in the above invention [10], the exterior materials for power storage devices as described in the above inventions [1] to [6] can be manufactured.

### BRIEF DESCRIPTION OF THE DRAWINGS

Some embodiments of the present disclosure are shown by way of example, and not limitation, in the accompanying figures.

FIG. 1 is a schematic cross-sectional view showing an all-solid-state battery as a power storage device according to an embodiment of the present disclosure.

FIG. 2 is a schematic enlarged cross-sectional view showing a main portion of FIG. 1.

FIG. 3 is an exploded perspective view schematically showing the all-solid-state battery according to the embodiment.

FIG. 4 is a bottom view (inner surface view) schematically showing a case body of the all-solid-state battery according to the embodiment.

FIG. 5 is a schematic cross-sectional view showing an exterior material for a case body in the all-solid-state battery according to the embodiment.

FIG. 6 is a schematic cross-sectional view for explaining a method for forming an opening portion in the exterior material according to the embodiment.

FIG. 7 is a schematic cross-sectional view for explaining a main portion of the exterior material having an opening portion according to the embodiment.

FIG. 8 is a schematic cross-sectional view showing a molding apparatus for forming the case body using the exterior material having an opening portion according to the embodiment.

FIG. 9 is a schematic cross-sectional view for explaining a heat sealing method according to the embodiment.

FIG. 10 is a schematic cross-sectional view showing a first modification of the all-solid-state battery according to the present disclosure.

FIG. 11 is a schematic cross-sectional view showing a second modification of the all-solid-state battery according to the present disclosure.

FIG. 12 is a schematic cross-sectional view showing a third modification of the all-solid-state battery according to the present disclosure.

FIG. 13 is a schematic cross-sectional view showing a fourth modification of the all-solid-state battery according to the present disclosure.

FIG. 14 is a cross-sectional view of a blade portion of a Pinnacle® blade used for forming an opening portion in an Example.

FIG. 15 is a perspective view of a blade portion of a Thomson blade used for forming an opening portion in an Example.

FIG. 16 is a plan view of a blade portion of an ultrasonic cutter used for forming an opening portion in a Comparative Example.

FIG. 17 is a plan view showing a forming test specimen in an Example.

FIG. 18 is a plan view schematically showing an insulation evaluation specimen.

FIG. 19 is a cross-sectional view schematically showing an insulation evaluation specimen, corresponding to the cross-section taken along the line X-X in FIG. 18.

### EMBODIMENTS FOR CARRYING OUT THE INVENTION

In the following paragraphs, some embodiments in the present disclosure will be described by way of example and not limitation. It should be understood based on this disclosure that various other modifications can be made by those in the art based on these illustrated embodiments.

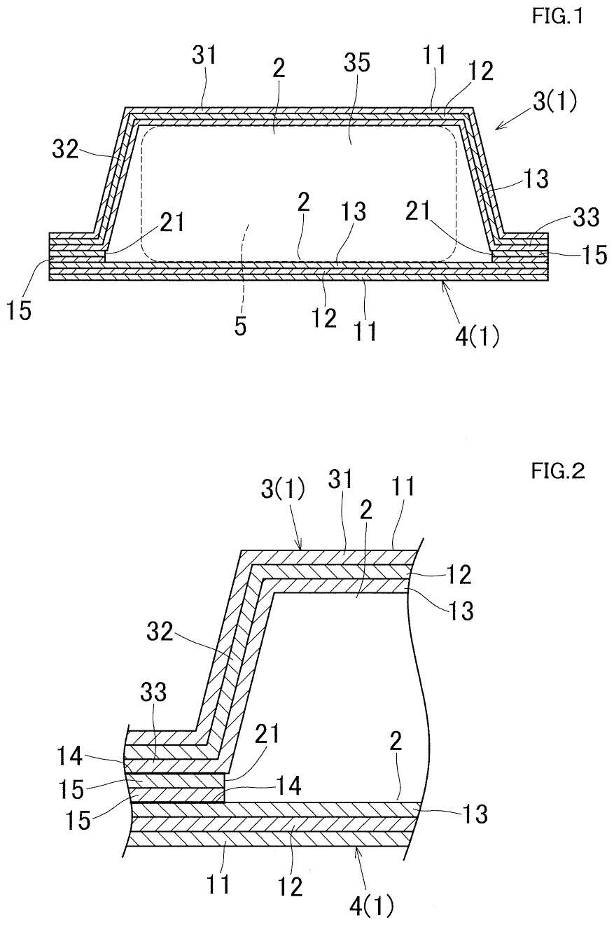

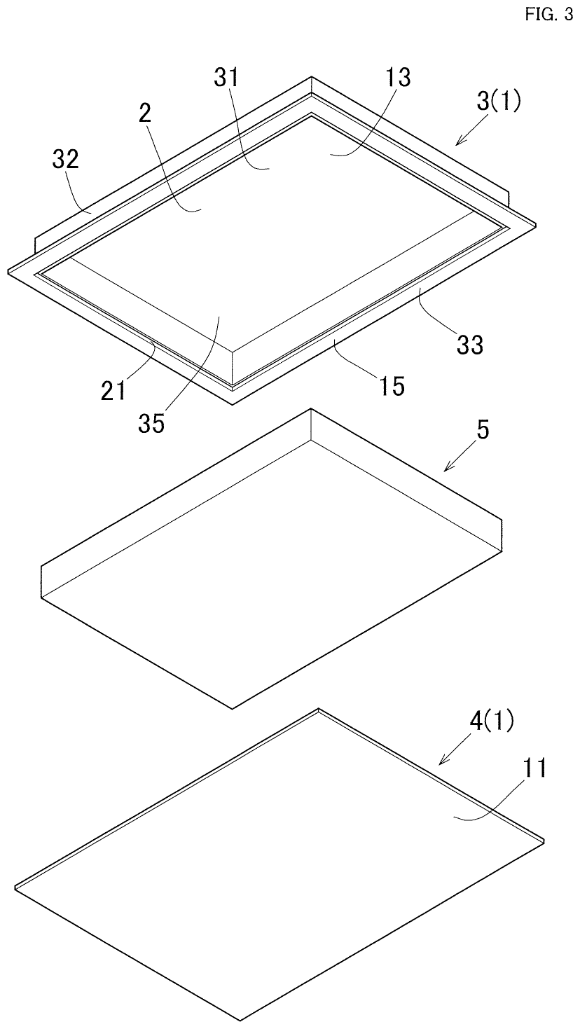

FIG. 1 is a schematic cross-sectional view showing an all-solid-state battery as a power storage device according to an embodiment of the present disclosure. FIG. 2 is a schematic enlarged cross-sectional view showing a main portion of FIG. 1. FIG. 3 is an exploded perspective view schematically showing an all-solid-state battery according to the embodiment. As shown in these figures, the all-solid-state battery of this embodiment includes a case body 3 and a sealing member 4, which together serve as a battery case (casing), and an all-solid-state battery cell 5 that is housed and sealed in the battery case.

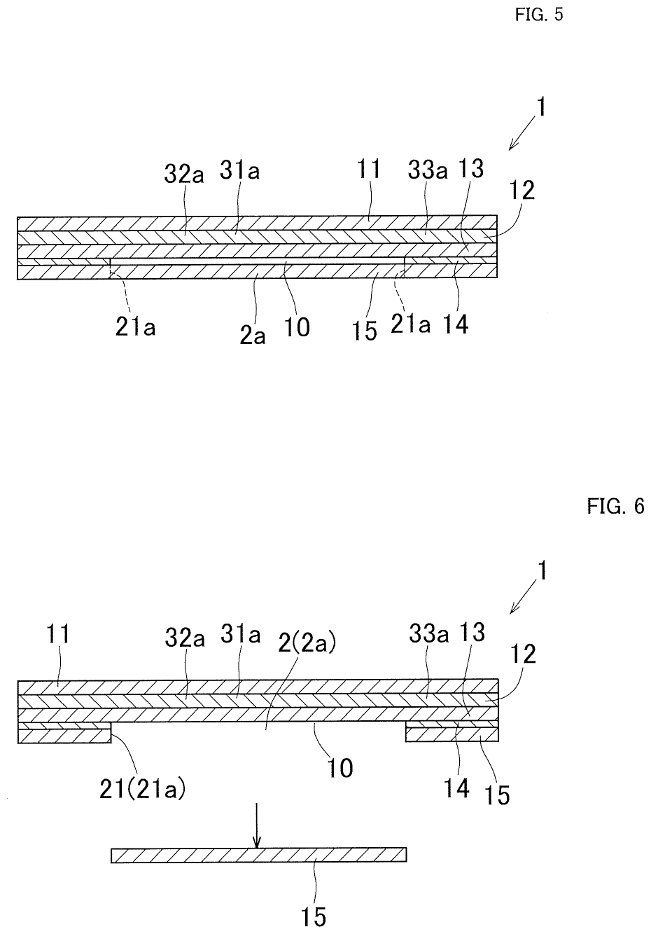

FIG. 5 is a schematic cross-sectional view showing an exterior material 1 forming the case body 3 in the all-solid-state battery according to the embodiment. As shown in the figure, the exterior material 1 includes: a base layer 11 disposed on the outermost side; a metal foil layer 12 laminated and bonded to the inner surface side of the base layer 11 via an adhesive layer; a heat-resistant gas barrier layer 13 laminated and bonded to the inner surface side of the metal foil layer 12 via an adhesive layer; and a sealant layer 15 laminated and bonded to the inner surface side of the heat-resistant gas barrier layer 13 via an adhesive layer 14. In the present disclosure, when describing the positions of the respective layers of the exterior material 1 in terms of direction, the direction toward the base layer 11 (upper side in FIG. 3) is referred to as the outer side, and the direction toward the sealant layer 15 (lower side in FIG. 3) is referred to as the inner side.

It should be noted that the exterior material 1 forming the sealing member 4 has the same configuration as the exterior material 1 forming the case body 3.

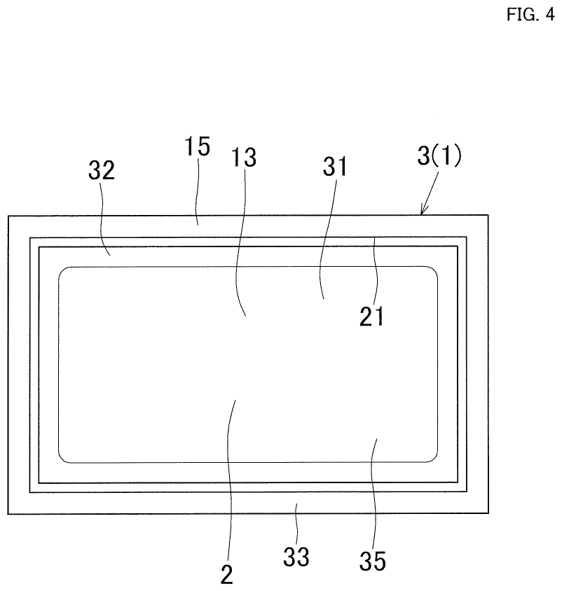

FIG. 4 is a schematic view showing the case body 3 as viewed from the lower surface side (inner surface side). As shown in FIGS. 1 to 4, the case body 3 is formed of a molded article of the exterior material 1, and integrally includes a top wall 31, sidewalls (peripheral sidewalls) 32 extending downward from the outer peripheral edge portion of the top wall 31, and a flange 33 provided on the outer periphery of the lower end portion of the sidewall 32. A housing portion 35 is formed inside the top wall 31 and the sidewall 32. Further, the sealing member 4 is formed of a sheet-shaped exterior material 1. The all-solid-state battery cell 5 is housed in the housing portion 35 of the case body 3, and the sealing member 4 is disposed so as to close a lower end opening portion of the housing portion 35. The sealing member 4 is arranged such that its sealant layer 15 faces inward (upward), and such that the sealant layer 15 of the flange 33 of the case body 3 and the sealant layers 15 of the outer peripheral edge portion of the sealing member 4 are overlapped facing each other. The overlapped sealant layers 15 are integrally joined by heat bonding (heat sealing), whereby an all-solid-state battery in which the all-solid-state battery cell 5 is hermetically housed within the casing (the case body 3 and the sealing member 4) is manufactured.

Further, in the case body 3 of the all-solid-state battery, an opening portion 2 is formed by removing the sealant layer 15 and the adhesive layer 14 in a portion corresponding to the housing portion 35. In the sealing member 4 as well, an opening portion 2 is formed by removing the sealant layer 15 and the adhesive layer 14 in a portion corresponding to the housing portion 35. Through the opening portions 2 of the case body 3 and the sealing member 4, the heat-resistant gas barrier layer 13 of the exterior material 1 is exposed to the inside of the housing portion 35 and is arranged to face the all-solid-state battery cell 5.

In the all-solid-state battery of this embodiment, although not illustrated, tab leads for extracting electricity are provided. This tab lead has one end (inner end) bonded and fixed to the all-solid-state battery cell 5 and is arranged such that an intermediate portion passes through a heat-sealed portion between the flange 33 of the case body 3 and the outer peripheral edge portion of the sealing member 4, and the other end is drawn out to the outside.

Details of each part of the all-solid-state battery in this embodiment will be described below.

The base layer 11 of the exterior material 1 is formed of a heat-resistant resin film having a thickness of 5 μm to 50 μm. As the resin film for the base layer 11, a stretched polyamide film, a stretched polyester film (PET, PBT, PEN, etc.), or a stretched polyolefin film (OPP, etc.) is preferably used.

The metal foil layer 12 has a thickness in the range of 5 μm to 120 μm and serves to block the ingress of oxygen and moisture from the surface (outer side). As the metal foil layer 12, an aluminum foil, a SUS foil (stainless steel foil), a copper foil, a nickel foil, and the like are preferably used. In this embodiment, the terms “aluminum,” “copper,” and “nickel” are used to include their alloys as well.

Further, applying plating or a similar treatment to the metal foil layer 12 reduces the risk of pinhole formation and thereby enhances its barrier performance against oxygen and moisture.

Furthermore, performing a chemical conversion treatment, such as chromate treatment, on the metal foil layer 12, further improves corrosion resistance, thereby more reliably preventing defects. Additionally, adhesion to the resin is improved, which further enhances durability.

The sealant layer (heat-sealable resin layer) 15 has a thickness set from 20 μm to 100 μm and is formed of a heat-adhesive (heat-fusible) resin film. Examples of resins forming the sealant layer 15 include polyethylene (LLDPE, LDPE, HDPE), polyolefins such as polypropylene, olefin-based copolymers, and a group including acid-modified products thereof and ionomers. For example, non-stretched polypropylene (CPP, IPP) can be preferably used.

As the sealant layer 15, in consideration of extracting electricity using tab leads, that is, ensuring sealability and adhesiveness with the tab leads, it is preferable to use a polypropylene-based resin, such as a non-stretched polypropylene film (e.g., CPP or IPP).

The heat-resistant gas barrier layer 13 is formed of a resin film having heat resistance and insulating properties. As the resin forming the heat-resistant gas barrier layer 13, it is preferable to use a resin selected from the group consisting of polyamides (such as 6-nylon, 66-nylon, and MXD nylon), polyesters (such as polyethylene terephthalate (PET)), polybutylene terephthalate (PBT), polyvinylidene chloride (PVDC), polyethylenes (LLDPE, LDPE, HDPE), polyolefins such as polypropylene, olefin-based copolymers, acid-modified products thereof, and ionomers.

In this embodiment, it is preferable to set the thickness (original thickness) of the heat-resistant gas barrier layer 13 to 3 μm to 50 μm, and more preferably to 10 μm to 40 μm. That is, when the thickness of the heat-resistant gas barrier layer 13 is set within this range, it is possible to reliably ensure the above-described effects of suppressing the permeation of hydrogen sulfide gas and water vapor gas. In addition, even if the sealant layer 15 melts and flows out due to thermal bonding, insulation can be reliably ensured by the heat-resistant gas barrier layer 13. In other words, if the heat-resistant gas barrier layer 13 is too thin, there is a risk that the gas permeation suppression effect and insulation cannot be ensured, which is undesirable. Conversely, if the heat-resistant gas barrier layer 13 is too thick, it not only prevents thinning of the exterior material 1, but also provides no significant benefit from increased thickness, which is therefore undesirable.

In this embodiment, it is preferable to use a resin film as the heat-resistant gas barrier layer 13. That is, since the entire film serves as the barrier layer, unlike vapor-deposited films and the like, barrier cracks do not occur, and barrier performance can be improved.

Furthermore, as the resin film forming the heat-resistant gas barrier layer 13, it is preferable to use a non-stretched film or a slightly stretched film, particularly a non-stretched film. That is, when a non-stretched film is used, moldability and gas barrier properties can be further improved.

The heat-resistant gas barrier layer 13 of this embodiment has favorable insulating properties, and even after the all-solid-state battery cell 5 is sealed by the case body 3 and the sealing member 4, which together serve as the exterior material 1 of this embodiment, favorable insulating properties are maintained.

Further, in this embodiment, it is preferable to adopt, as the heat-resistant gas barrier layer 13, one having an arithmetical mean height Sa as surface roughness before the formation of the opening portion 2 in the range of 0.04 μm to 1.5 μm. That is, when the surface roughness of the heat-resistant gas barrier layer 13 is within the above range, slip properties with respect to the forming punch 7 are improved, and moldability is enhanced, which is preferable. In other words, if the arithmetical mean height Sa is less than 0.04 μm, the contact area with the forming punch 7 becomes large, resulting in increased frictional resistance, which may lead to a decrease in moldability and is therefore undesirable. On the other hand, if the arithmetical mean height Sa exceeds 1.5 μm, there is a risk of adhesion defects in the adhesive layer 14, and adhesiveness may be degraded, which is also undesirable.

In this embodiment, it is preferable that the resins forming the heat-resistant gas barrier layer 13 and the sealant layer 15 have a predetermined hydrogen sulfide (H₂S) gas permeability. Specifically, it is preferable that the heat-resistant gas barrier layer 13 and the sealant layer 15 be formed of a resin having a hydrogen sulfide gas permeability of 15 {cc·mm/(m²·D·MPa)} or less, more preferably 10 {cc·mm/(m²·D·MPa)} or less, and even more preferably 4.0 {cc·mm/(m²·D·MPa)} or less, as measured in accordance with JIS K7126-1. That is, when the hydrogen sulfide gas permeability of the heat-resistant gas barrier layer 13 and the sealant layer 15 is set to the above specific value or less, the hydrogen sulfide gas generated by the reaction between the solid electrolyte material and moisture in the outside air can be effectively prevented from leaking out through the heat-resistant gas barrier layer 13 and the sealant layer 15. In other words, if the hydrogen sulfide gas permeability of the heat-resistant gas barrier layer 13 and the sealant layer 15 is too high, there is a risk that the generated hydrogen sulfide gas may leak to the outside through the exterior material 1 (the heat-resistant gas barrier layer 13 and the sealant layer 15), which is undesirable.

For reference, the “D” included in the unit of hydrogen sulfide gas permeability stands for “Day (24 h).”

In this embodiment, as the adhesive layers bonding between the base layer 11 and the metal foil layer 12 (first adhesive layer), between the metal foil layer 12 and the gas barrier layer 13 (second adhesive layer), and between the gas barrier layer 13 and the sealant layer 15 (third adhesive layer) 14, dry lamination adhesives, such as polyurethane-based adhesives, acrylic-based adhesives, polyacrylic acid ester-based adhesives, modified polypropylene-based adhesives, polyester-based adhesives, polyamide-based adhesives, and epoxy-based adhesives, are preferably used. The thicknesses of the first to third adhesive layers are preferably set in the range of 1 μm to 6 μm.

Regarding the second adhesive layer, instead of using an adhesive, an adhesive resin (such as a polyolefin-based resin including polyolefin, carboxylic acid-modified polyolefin, metal-modified polyolefin, a polyvinyl acetate-based resin, a (meth)acrylic resin, or an amino resin) may be used to laminate the metal foil layer and the heat-resistant gas barrier layer by co-extruding the adhesive resin and the resin forming the heat-resistant gas barrier layer on the metal foil layer (extrusion lamination method). Alternatively, a method may be employed in which a laminate previously formed by laminating the adhesive resin and the heat-resistant gas barrier layer is laminated onto the metal foil layer by a thermal lamination method, or a method in which the adhesive resin in a molten state is poured between the metal foil layer and the heat-resistant gas barrier layer while bonding the metal foil layer and the heat-resistant gas barrier layer together (sand lamination method), thereby laminating the metal foil layer and the heat-resistant gas barrier layer.

In this embodiment, the opening portion 2 on the case body 3 side has its outer peripheral edge portion 21 provided on the flange 33 of the case body 3. Furthermore, the opening portion 2 on the sealing member 4 side is formed such that its opening edge portion 21 corresponds to the opening edge portion 21 of the opening portion 2 in the case body 3.

In this embodiment, in the opening portions 2 formed in the case body 3 and the sealing member 4, no adhesive layer 14 for bonding the sealant layer 15 to the heat-resistant gas barrier layer 13 is provided, and the heat-resistant gas barrier layer 13 is exposed on the inner side through the opening portion 2. In the state in which the all-solid-state battery is fabricated, the heat-resistant gas barrier layer 13 is arranged to face the upper surface, peripheral side surfaces, and lower surface of the all-solid-state battery cell 5.

In this embodiment, no adhesive layer 14 is provided in the opening portion 2. However, the present disclosure is not limited to this, and the adhesive layer 14 may be provided in at least part of the opening portion 2. Nevertheless, as in this embodiment, the absence of the adhesive layer 14 can enhance heat dissipation.

Next, a method for manufacturing the exterior material 1 in this embodiment will be described. In the present disclosure, it should be understood that the method for manufacturing the exterior material 1 is not limited to the method described below. The same applies to the methods for manufacturing the case body 3 and the all-solid-state battery, which is described later.

In this embodiment, first, a laminate without the sealant layer is manufactured, for example, by a dry lamination method. That is, a resin film for the base layer 11 is bonded to the outer surface of a metal foil (metal foil layer 12) that has undergone, as needed, a surface treatment or a chemical conversion treatment, via an adhesive, and a resin film for the heat-resistant gas barrier layer 13 is bonded to the inner surface of the metal foil via an adhesive. Thus, a laminate without the sealant layer is formed. In this laminate, the metal foil layer 12 and the heat-resistant gas barrier layer 13 are laminated on the inner surface side of the base layer 11.

It is also possible to fabricate the laminate without the sealant layer by an extrusion lamination method. That is, the above-described laminate may be fabricated by extruding and laminating a resin composition for the base layer 11 and a resin composition for the heat-resistant gas barrier layer 13 onto the outer and inner surfaces, respectively, of the metal foil.

Next, a resin film for the sealant layer 15 is bonded to the inner surface (the inner surface of the heat-resistant gas barrier layer 13) of the above-described laminate without the sealant layer via an adhesive (adhesive layer 14), thereby forming the sealant layer 15, with prior adjustments being made so that the portion of the sealant layer 15 corresponding to the opening-portion-intended portion 2a, where the opening portion 2 is to be formed, can be reliably peeled off and removed by the following method.

As shown in FIG. 5, in a first formation method, when forming the sealant layer 15 on the heat-resistant gas barrier layer 13, an adhesive serving as the adhesive layer 14 is applied to the inner surface of the resin film functioning as the heat-resistant gas barrier layer 13 using a gravure roll or the like, and a resin film serving as the sealant layer 15 is bonded via the adhesive layer 14. At this time, an adhesive-free portion 10 is previously formed at the opening-portion-intended portion 2a by omitting application of the adhesive at that region. Then, a resin film for the sealant layer is bonded to the heat-resistant gas barrier layer 13 having the adhesive-free portion 10 and dried.

Thereafter, as shown in FIG. 6, an opening portion 2 is formed by cutting out the portion of the sealant layer 15 located in the adhesive-free portion 10, which corresponds to the opening-portion-intended portion 2a (first formation method). This cutting is performed using a laser cutter, a rotary blade, a punching blade (such as a Thomson blade, a Pinnacle® blade, and other etched blades), an ultrasonic cutter, or the like. Among these, it is preferable to use a laser cutter or a punching blade capable of high-precision processing, especially preferably a punching blade that is less affected by heat.

As a second formation method, before applying an adhesive to the heat-resistant gas barrier layer 13, a release paper is tentatively fixed to a region of the heat-resistant gas barrier layer 13 corresponding to the opening-portion-intended portion 2a. In that state, an adhesive is applied to the heat-resistant gas barrier layer 13 using a gravure roll or the like, and then, a resin film for the sealant layer 15 is bonded to the adhesive-coated surface and dried.

Thereafter, the opening-portion-intended portion 2a of the sealant layer 15 corresponding to the temporarily fixed release paper portion is cut out together with the adhesive and the release paper using the cutting method described above, thereby forming the opening portion 2. When employing this second formation method, any of the following may be removed: only the resin film for the sealant layer, both the resin film and the adhesive, or the resin film, the adhesive, and the release paper. In other words, the release paper or adhesive may optionally be left in place.

In this manner, the opening portion 2 is formed in the exterior material 1 to produce an exterior material having an opening portion.

As another formation method, it is also conceivable to form a through-hole as the opening portion 2 in the resin film for the sealant layer 15 before bonding it to the heat-resistant gas barrier layer 13, and to bond the resin film for the sealant layer having a pre-formed opening portion, to the heat-resistant gas barrier layer 13 via an adhesive (another formation method). However, in this alternative formation method, it is difficult to apply the adhesive uniformly, and also difficult to bond the resin film for the sealant layer, having the opening portion, with high accuracy. Accordingly, in this embodiment, it is preferable to adopt the above-described first and second formation methods, and particularly preferable to adopt the first formation method.

Here, as shown in FIGS. 5 and 6, the sheet-shaped exterior material 1 before mold forming includes a top wall-intended portion 31a, which is a portion to become the top wall 31; a sidewall-intended portion 32a, which is a portion to become the side wall 32; and a flange-intended portion 33a, which is a portion to become the flange 33.

In this embodiment, the outer peripheral edge portion 21a of the opening-portion-intended portion 2a is positioned within the range of the flange-intended portion 33a.

Further, the flange-intended portion 33a includes a heat-sealed portion for heat sealing, as will be described later.

It should be noted that the exterior material 1 shown in FIGS. 5 and 6 is described as an example for forming the exterior material 1 with an opening portion for the case body 3, but the same applies to the case of forming the exterior material 1 with an opening portion for the sealing member 4.

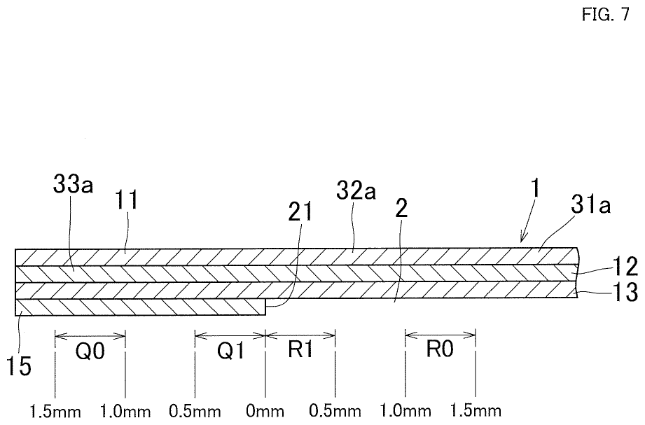

FIG. 7 is an enlarged cross-sectional view showing the region around the edge portion 21 of the opening portion 2 in the exterior material 1 with an opening portion. As shown in the figure, in the vicinity of the edge portion 21 of the opening portion 2 of the exterior material 1, changes may occur in the heat-resistant gas barrier layer 13 or the sealant layer 15 due to effects during the opening-portion-forming process, such as thermal effects, and such changes may lead to a deterioration in the function as an all-solid-state battery.

Therefore, in this embodiment, by specifying the properties of the heat-resistant gas barrier layer 13 and the sealant layer 15 in the vicinity of the edge portion 21 of the opening portion in the exterior material 1 with an opening portion, an all-solid-state battery having sufficient performance is provided.

Specifically, in this embodiment, a range from 1 mm to 1.5 mm measured from the position of the edge portion 21 of the opening portion 2 (the 0 mm position in FIG. 7) toward the opening portion side (the right side in the figure) is defined as the opening-portion-side standard region R0, and a range from 0 mm to 0.5 mm measured from the position of the edge portion 21 of the opening portion 2 toward the opening portion side is defined as the opening-portion-side evaluation region R1. Further, when the thickness of the heat-resistant gas barrier layer 13 in the opening-portion-side standard region R0 is defined as “T1,” the thickness in the opening-portion-side evaluation region R1 is defined as “T1,” and the thickness change ratio in the opening-portion-side evaluation region R1 is defined as “ΔT,” it is configured so as to satisfy the following expression (1).

$$Δ T = ( \vert T 0 - T 1 \vert / T 0 ) \times 100 ≦ 10 \% \qquad ( 1 )$$

where, the thickness T0 in the opening-portion-side standard region R0 of the heat-resistant gas barrier layer 13 is the average thickness obtained by measuring the thickness at five arbitrary points in the opening-portion-side standard region R0 through cross-sectional observation using a microscope. Note that the thickness T0 is substantially the same as the original thickness of the heat-resistant gas barrier layer 13 before the formation of the opening portion 2, and therefore, the original thickness may be used as T0.

Further, the thickness T1 in the opening-portion-side evaluation region R1 of the heat-resistant gas barrier layer 13 is the minimum value obtained by measuring the thickness at five arbitrary points in the opening-portion-side evaluation region R1 through cross-sectional observation using a microscope.

In this embodiment, when the thickness change ratio ΔT is 10% or less, moldability and insulating properties can be improved, as will be described later.

Further, in this embodiment, when the arithmetical mean height in the opening-portion-side standard region R0 of the heat-resistant gas barrier layer 13 is defined as “Sa0,” the arithmetical mean height in the opening-portion-side evaluation region R1 of the heat-resistant gas barrier layer 13 is defined as “Sa1,” and the absolute value of the difference between the arithmetical mean height in the opening-portion-side evaluation region R1 and that in the opening-portion-side standard region R0 is defined as “ΔSa,” the configuration is such that the following expression (2) is satisfied.

$$Δ Sa = \vert Sa 1 - Sa 0 \vert ≦ 2 μ m \qquad ( 2 )$$

where, the arithmetical mean height Sa0 in the opening-portion-side standard region R0 of the heat-resistant gas barrier layer 13 is the average value obtained by measuring three arbitrary points on the surface of the opening-portion-side standard region R0 of the heat-resistant gas barrier layer 13 using a white light interferometer. Note that the arithmetical mean height Sa0 is substantially the same as the original arithmetical mean height of the heat-resistant gas barrier layer 13 before the formation of the opening portion 2, and therefore, the original arithmetical mean height may be used as Sa.

Further, the arithmetical mean height Sa1 in the opening-portion-side evaluation region R1 of the heat-resistant gas barrier layer 13 is the average value obtained by measuring three arbitrary points on the surface of the opening-portion-side evaluation region R1 of the heat-resistant gas barrier layer 13 using a white light interferometer.

In this embodiment, when the difference ΔSa in arithmetical mean height is 2 μm or less, heat dissipation and cooling performance can be improved, as will be described later.

In this embodiment, the sealant layer 15 includes a non-opening-portion-side standard region Q0, which is defined as a region extending from 1 mm to 1.5 mm toward the non-opening portion side (left side in the figure) from an edge portion 21 (corresponding to the 0 mm position in FIG. 7) of the opening portion 2, and a non-opening-portion-side evaluation region Q1, which is defined as a region extending from 0 mm to 0.5 mm toward the non-opening portion side from the edge portion 21 of the opening portion 21. The exterior material is configured such that the following relational expression (3) is satisfied, where H0 is the thickness of the sealant layer 15 in the standard region Q0, and H1 is the thickness of the sealant layer 15 in the evaluation region Q1.

$$Δ H = ( \vert H 0 - H 1 \vert / H 0 ) \times 100 ≦ 10 \% \qquad ( 3 )$$

where the thickness H0 in the non-opening-portion-side standard region Q0 of the sealant layer 15 is the average value of the thicknesses measured at five arbitrary points in the non-opening-portion-side standard region Q0, based on cross-sectional observation using a microscope. Note that the thickness H0 is substantially the same as the original thickness of the sealant layer 15 before the formation of the opening portion 2, and therefore, the original thickness may be used as H0.

Further, the thickness H1 in the non-opening-portion-side evaluation region Q1 of the sealant layer 15 is the maximum value of the thicknesses measured at five arbitrary points in the non-opening-portion-side evaluation region Q1, based on cross-sectional observation using a microscope.

In this embodiment, when the thickness change ratio ΔH is 10% or less, an all-solid-state battery with a favorable appearance can be produced, as will be described later.

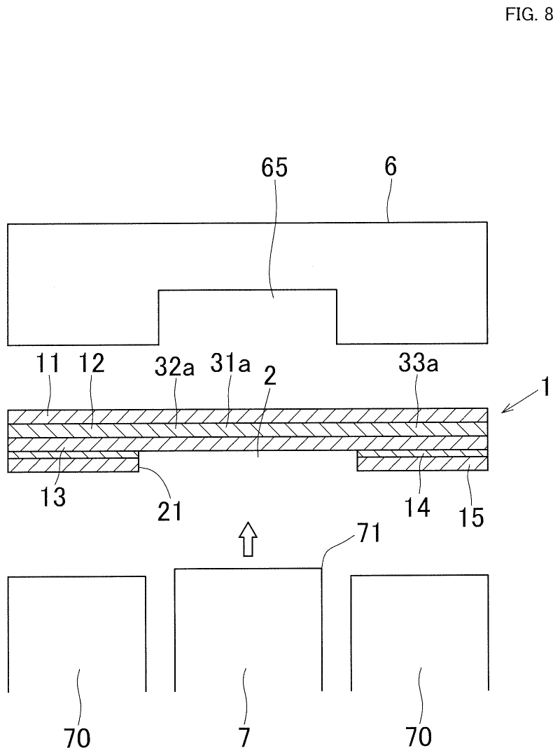

FIG. 8 is a schematic cross-sectional view showing a molding apparatus for forming the case body 3 using the exterior material 1 with an opening portion. As shown in the figure, this molding apparatus includes a die 6 serving as an upper die, and a punch 7 and a blank holder (wrinkle-preventing die) 70 serving as lower dies.

A molding recess 65 for forming the housing portion 35 (top wall 31 and sidewall 32) of the case body 3 is formed on the lower surface side of the die 6.

The punch 7 is arranged in alignment with the molding recess 65 of the die 6, and the blank holder (wrinkle-preventing die) 70 is arranged around the outer periphery of the punch 7 so as to face the lower surface outer peripheral portion of the die 6.

Then, the exterior material 1 with an opening portion serving as a molding material is arranged such that its sidewall-intended portion 32a is aligned with the tip end outer peripheral edge portion of the punch 7. In this state, the flange-intended portion 33a of the exterior material 1 is clamped and supported between the outer peripheral portion of the die 6 and the blank holder (wrinkle-preventing die) 70, and the exterior material 1 is press-molded by driving the punch 7 into the molding recess 65 of the die 6. As a result, a molded article (molded material) for the case body is formed, which includes the housing portion 35 (top wall 31 and sidewall 32) and a flange 33 extending outward from the housing portion 35. Subsequently, by cutting the flange 33 of the molded article to a predetermined size, the case body 3 of this embodiment is produced. In this case body 3, as shown in FIGS. 1 to 4, the opening portion 2 is disposed over the entire region of the housing portion 35, and the outer peripheral edge portion 21 of the opening portion 2 is disposed on the flange 33.

Here, in a case where the case body 3 is deep-drawn by driving a punch 7 into a portion of the exterior material 1 corresponding to the opening portion 2, as in this embodiment, a large tensile stress acts on the opening-portion-side evaluation region R1 (see FIG. 7) of the heat-resistant gas barrier layer 13. Therefore, when the thickness change ratio ΔT in the opening-portion-side evaluation region R1 is large, a locally thinned portion may be generated in the heat-resistant gas barrier layer 13 in the opening-portion-side evaluation region R1, which may cause pinholes or cracks, leading to a deterioration in moldability as well as a potential decline in insulating properties.

In contrast, in this embodiment, the above relational expression (1), in which the thickness change ratio ΔT is 10% or less, is satisfied. Namely, the thickness change ratio ΔT is small. The thickness of the heat-resistant gas barrier layer 13 remains substantially uniform with no locally thinned portions. Therefore, the occurrence of pinholes, cracks, and the like can be suppressed, and moldability and insulating properties can be improved.

When forming the case body 3, the flange-intended portion 33a of the exterior material 1 is clamped by the outer peripheral portion of the die 6 and the blank holder (wrinkle-preventing die) 70. At this time, a significant pressure is applied by the blank holder 70 to the non-opening-portion-side evaluation region Q1 of the sealant layer 15 in the exterior material 1. Therefore, if the thickness change ratio ΔH in the non-opening-portion-side evaluation region Q1 of the sealant layer 15 is large, wrinkles may be formed in the region Q1, potentially impairing the appearance of the molded article, i.e., the case body 3.

In contrast, in this embodiment, the above relational expression (3), in which the thickness change ratio ΔH is 10% or less, is satisfied. Namely, the thickness change ratio ΔH is small. The pressure applied by the blank holder (wrinkle-preventing die) 70 during forming is uniformly distributed across the entire non-opening-portion-side evaluation region Q1. As a result, wrinkles are not formed in the flange, and a favorable appearance can be obtained for the case body 3, and ultimately for the all-solid-state battery.

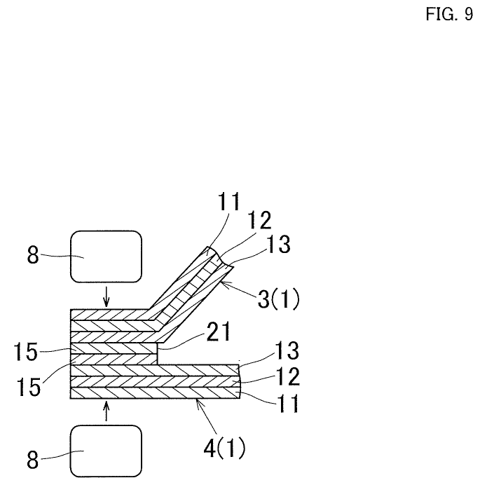

FIG. 9 is a schematic cross-sectional view for explaining a heat sealing method used in this embodiment when producing the all-solid-state battery by heat sealing the case body 3 and the sealing member 4. As shown in the figure, in the heat sealing method of this embodiment, a pair of sealing dies 8 is used to heat seal the flange 33 of the case body 3 and the outer peripheral edge portion of the sealing member 4, which is a sheet-shaped exterior material 1 having the opening portion 2 formed therein and cut to a predetermined size.

On the other hand, the all-solid-state battery cell 5 is housed in the housing portion 35 of the case body 3 to be subjected to heat sealing, and the sealing member 4 is disposed so as to close the housing portion 35 from below. At the same time, the sealant layer 15 of the flange 33 of the case body 3 and the sealant layer 15 of the outer peripheral edge portion of the sealing member 4 are arranged to face and overlap each other. In this state, the flange 33 of the case body 3 and the outer peripheral edge portion of the sealing member 4 are clamped and heated by the pair of sealing dies 8. As a result, the overlapping sealant layers 15 are heat sealed and integrally joined, thereby producing an all-solid-state battery in which the all-solid-state battery cell 5 is hermetically housed in the case body 3 and the sealing member 4.

Here, in this embodiment, it is preferable to adjust the resin forming the sealant layer 15 to have a melt flow rate (MFR) of 2 to 20 g/10 min (230° C., load: 2.16 kgf). That is, when the MFR is within this range, the meltability during heat sealing is improved, allowing a favorable heat-sealed portion to be formed, thereby enhancing seal strength. In other words, if the MFR is too low, resin flow during heat sealing becomes poor, making it difficult to form a favorable heat-sealed portion and potentially resulting in a reduction in sealing performance. Conversely, if the MFR is too high, excessive resin flow may occur during heat sealing, also making it difficult to form a favorable heat-sealed portion and potentially causing a reduction in sealing performance.

The size and shape of the opening portion 2 provided in the sealing member 4 may be larger or smaller than the lower surface of the all-solid-state battery cell 5. In order to improve heat dissipation, it is preferable to form the opening portion 2 of the sealing member 4 to be large; however, it is more preferable to make it equal in size to the outer peripheral edge portion 21 (sealant layer) of the flange of the case body.

According to the all-solid-state battery of this embodiment having the above-described configuration, the heat-resistant gas barrier layer 13 is provided between the metal foil layer 12 and the sealant layer 15 in the case body 3 and the sealing member 4, and openings 2 in which part of the sealant layer 15 is removed are formed in the top wall 31 and the sidewall 32. Therefore, the heat generated from the all-solid-state battery cell 5 is efficiently transferred and dissipated to the metal foil layer 12 via the opening portions 2 and the heat-resistant gas barrier layer 13 without being blocked by the sealant layer 15, thereby ensuring sufficient heat dissipation and cooling performance.

Particularly in this embodiment, since the outer peripheral edge portion 21 of the opening portion 2 in the case body 3 is set in the flange 33 of the case body 3, it is possible to form a large opening portion 2 covering almost the entire area of the all-solid-state battery cell 5, thereby further improving heat dissipation and cooling performance.

In the drawings such as FIG. 1, the side wall 32 of the case body 3 and the side surface of the all-solid-state battery cell 5 are shown as being spaced apart, but in actuality, the sidewall 32 of the case body 3 and the side surface of the all-solid-state battery cell 5 are in contact with each other, and the vicinity of the edge portion 21 of the opening portion 2 in the heat-resistant gas barrier layer 13—namely, the opening-portion-side evaluation region R1 of the heat-resistant gas barrier layer 13 (see FIG. 7)—is also in contact with the side surface of the all-solid-state battery cell 5. Therefore, if the difference ΔSa between the arithmetical mean height of the heat-resistant gas barrier layer 13 in the opening-portion-side evaluation region R1 and the arithmetical mean height of the heat-resistant gas barrier layer 13 in the opening-portion-side standard region R0 is large, change in surface roughness may prevent sufficient contact between the opening-portion-side evaluation region R1 of the heat-resistant gas barrier layer 13 and the enclosed all-solid-state battery cell 5, which may result in a decrease in cooling and heat dissipation performance.

In contrast, in this embodiment, since the above relational expression (2), in which the difference ΔSa in arithmetical mean height is 2 μm or less, is satisfied. That is, since the difference ΔSa in arithmetical mean height is small, the all-solid-state battery cell 5 closely adheres to the opening-portion-side evaluation region R1 of the heat-resistant gas barrier layer 13, thereby further improving cooling and heat dissipation performance.

Furthermore, according to the all-solid-state battery of this embodiment, since the heat-resistant gas barrier layer 13 is disposed on the inner surface side of the metal foil layer 12, even if hydrogen sulfide gas or the like is generated due to a reaction between the solid electrolyte of the all-solid-state battery cell 5 and moisture in the outside air, leakage of such gas can be reliably prevented by the heat-resistant gas barrier layer 13. In addition, the gas barrier function of the heat-resistant gas barrier layer 13 also prevents the ingress of moisture such as water vapor from the outside. This suppresses the generation of hydrogen sulfide gas itself due to a reaction between the moisture and the solid electrolyte, and thus more reliably prevents the leakage of hydrogen sulfide gas or the like.

In this embodiment, it is preferable to employ, as the resin forming the heat-resistant gas barrier layer 13, a material having a water vapor transmission rate of 50 (g/m²/day) or less, as measured in accordance with JIS K7129-1 (humidity sensor method, 40° C., 90% Rh). That is, when this configuration is adopted, the ingress of moisture can be more reliably prevented by the heat-resistant gas barrier layer 13, and the generation and leakage of hydrogen sulfide gas can also be more reliably prevented.

In this embodiment, it is preferable to employ a resin having a thermal conductivity of 0.2 W/m·K or higher to form the heat-resistant gas barrier layer 13. That is, when this configuration is adopted, the sufficient thermal conductivity of the heat-resistant gas barrier layer 13 can be achieved, so that the cooling performance of the all-solid-state battery cell 5 can be further improved.

In the all-solid-state battery of this embodiment, although the sealant layer 15 is not present between the all-solid-state battery cell 5 and the metal foil layer 12 in the region where the opening portion 2 is formed, the insulating heat-resistant gas barrier layer 13 is disposed between them. As a result, insulation can be reliably ensured by the heat-resistant gas barrier layer 13.

In addition, when forming the opening portion 2 in the exterior material 1 by cutting with a laser cutter or the like, a damaged portion may be formed at the outer peripheral edge portion 21 of the opening portion due to the laser cutting, which may cause defects such as cracks and pinholes. However, in this embodiment, since the outer peripheral edge portion 21 of the opening portion is formed in the flange 33 of the case body 3, it is possible to avoid adverse effects caused by the damaged portion. That is, since the flange 33 of the molded article 3 is heat-sealed, a resin accumulation portion formed by the heat sealing is formed at the damaged portion (outer peripheral edge portion 21 of the opening portion). Therefore, the damaged portion can be covered and repaired by the resin accumulation portion, thereby reliably preventing any adverse effects caused by damage from laser cutting.

In this embodiment, it is preferable to adopt, as the resin forming the heat-resistant gas barrier layer 13, a resin having a melting point that is 10° C. or more higher than that of the resin forming the sealant layer 15. That is, when the heat-resistant gas barrier layer 13 is set to have a high melting point, even if the sealant layer 15 is melted during the thermal bonding of the exterior material 1, the heat-resistant gas barrier layer 13 can be prevented from melting and flowing out. Therefore, the gas permeation suppression effect and insulating properties provided by the heat-resistant gas barrier layer 13 can be more reliably achieved.

In the all-solid-state battery of this embodiment, since the sealant layer 15 is not formed in the portion of the exterior material 1 corresponding to the all-solid-state battery cell 5, the space for accommodating the all-solid-state battery cell 5 can be made larger (thicker) by that amount. Therefore, in the all-solid-state battery of this embodiment, compared to conventional all-solid-state batteries, a larger-sized all-solid-state battery cell 5 can be accommodated without changing the external dimensions of the case body 3, thereby enabling a thinner design while achieving higher output and greater capacity.

In the all-solid-state battery of this embodiment, the sealant layer 15 is formed on the flange 33 that extends around the entire periphery of the case body 3. This configuration allows the all-solid-state battery to be reliably sealed along its entire periphery, thereby ensuring favorable sealing performance.

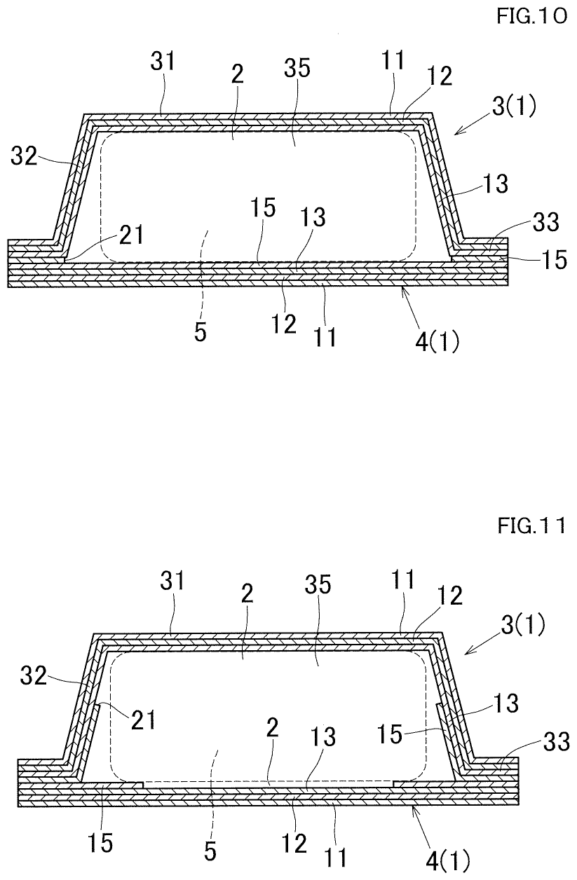

In the above-described embodiment, the configuration in which the opening portion 2 is formed in both the case body 3 and the sealing member 4 has been described by way of example. However, the present disclosure is not limited to this configuration. For example, as shown in FIG. 10, the opening portion 2 may be formed only in the case body 3, and not in the sealing member 4.

In the all-solid-state battery of this embodiment shown in FIG. 1, the case body 3 is disposed on the upper side and the sealing member 4 is disposed on the lower side. However, the present disclosure is not limited to this configuration. In the present disclosure, it is also possible to invert the all-solid-state battery shown in FIG. 1, that is, to dispose the molded case body 3 on the lower side and the sheet-shaped sealing member 4 on the upper side.

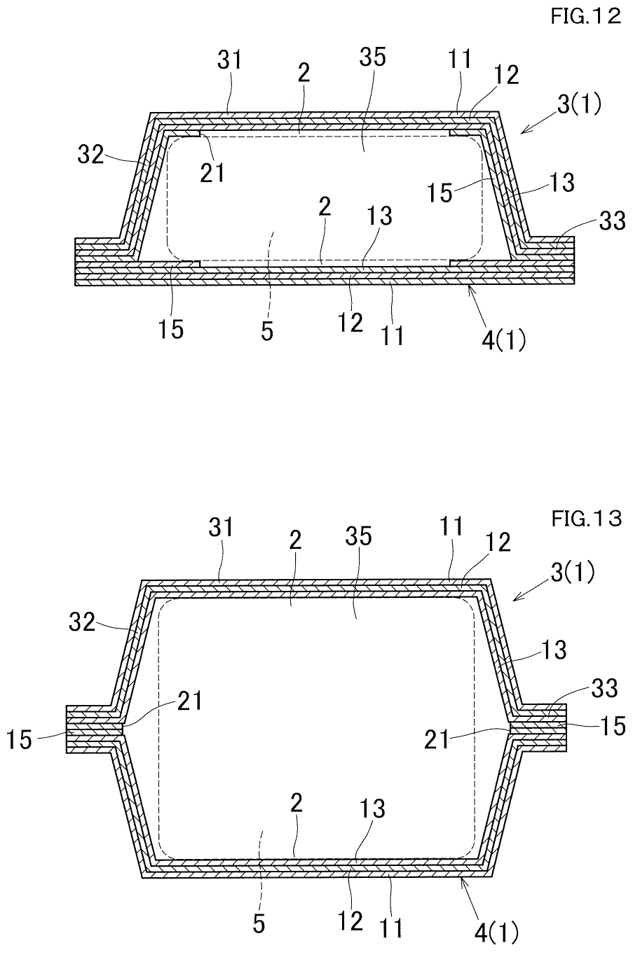

In the above-described embodiment, the edge portion 21 of the opening portion 2 is set within the flange 33, but the present disclosure is not limited thereto. For example, in the present disclosure, as shown in FIG. 11, the edge portion 21 of the opening portion 2 may be set on the sidewall 32 of the case body 3, or as shown in FIG. 12, the edge portion 21 of the opening portion 2 may be set on the top wall 31 (bottom wall) of the case body 3. That is, in the present disclosure, the shape and size of the opening portion 2 are not particularly limited.

Furthermore, in the present disclosure, a molded article may also be used as the sealing member 4. For example, as shown in FIG. 13, a tray-shaped molded article having an inverted shape of the case body 3 may be used as the sealing member 4, and the casing of the all-solid-state battery may be formed by the molded case body 3 and the tray-shaped molded sealing member 4. In this case, by using a configuration for the sealing member 4 similar to that of the case body 3 described above, the same effects can also be obtained in the sealing member 4.

In the above-described embodiment, an all-solid-state battery has been described as an example of the power storage device of the present disclosure. However, the present disclosure is not limited thereto and can also be applied to other power storage devices, including those other than all-solid-state batteries.

### EXAMPLES

TABLE 1

| | | | | | | Film thickness before punching of the heat-fusible | | | |
|---|---|---|---|---|---|---|---|---|---|
| | | | | | | resin layer and Sa measurement results | | | |
| | | | | Metal | Heat resistance gas | | | | |
| | | | Base | foil | barrier layer | | | Sealant layer | |
| | Punching method | | layer | layer | | Thickness | Sa | | Thickness |
| | Type | Processing conditions | (μm) | (μm) | Type | (μm) | (μm) | Type | (μm) |
| Ex. 1 | Pinnacle | Stainless steel blade, Blade | ONY15 | AL80 | PET | 12.0 | 0.04 | CPP(rPP/bPP/ | 80 |
| | blade | angle 60°, Blade depth 0.3 | | | | | | rPP = 1.5/7/1.5) | |
| | | mm | | | | | | | |
| Ex. 2 | Pinnacle | Stainless steel blade, Blade | ONY15 | AL80 | PET | 12.0 | 0.04 | CPP(rPP/bPP/ | 80 |
| | blade | angle 40°, Blade depth 0.3 | | | | | | rPP = 1.5/7/1.5) | |
| | | mm | | | | | | | |
| Ex. 3 | Pinnacle | Stainless steel blade, Blade | ONY15 | AL80 | ONY | 15.0 | 0.03 | CPP(rPP/bPP/ | 80 |
| | blade | angle 40°, Blade depth 0.3 | | | | | | rPP = 1.5/7/1.5) | |
| | | mm | | | | | | | |
| Ex. 4 | Thomson | High-tensile steel blade, | ONY15 | AL80 | PET | 12.0 | 0.04 | CPP(rPP/bPP/ | 80 |
| | blade | Blade angle 42°, Blade | | | | | | rPP = 1.5/7/1.5) | |
| | | depth 0.9 mm | | | | | | | |
| Ex. 5 | Laser | CO₂ laser Output 30% | ONY15 | AL80 | PET | 12.0 | 0.04 | CPP(rPP/bPP/ | 80 |
| | | | | | | | | rPP = 1.5/7/1.5) | |
| Comp. | Laser | CO₂ laser Output 40% | ONY15 | AL80 | PET | 12.0 | 0.04 | CPP(rPP/bPP/ | 80 |
| Ex. 1 | | | | | | | | rPP = 1.5/7/1.5) | |
| Comp. | Laser | CO₂ laser Output 50% | ONY15 | AL80 | PET | 12.0 | 0.04 | CPP(rPP/bPP/ | 80 |
| Ex. 2 | | | | | | | | rPP = 1.5/7/1.5) | |
| Comp. | Ultrasonic | Tool steel blade, Blade | ONY15 | AL80 | PET | 12.0 | 0.04 | CPP(rPP/bPP/ | 80 |
| Ex. 3 | cutting | angle 30°, Blade depth 18.5 | | | | | | rPP = 1.5/7/1.5) | |
| | | mm | | | | | | | |

TABLE 2

| | Film thickness near the edge of the opening portion and Sa measurement results | | | | | | | | | Performance evaluation | |
|---|---|---|---|---|---|---|---|---|---|---|---|
| | Heat-resistance barrier layer | | | | | | Sealant layer | | | results | |
| | T0 | T1 | ΔT | Sa0 | Sa1 | ΔSa | H0 | H1 | ΔH | | Insulating |
| | (μm) | (μm) | (%) | (μm) | (μm) | (μm) | (μm) | (μm) | (%) | Formability | property |
| Ex. 1 | 12.0 | 12.0 | 0.0 | 0.04 | 0.04 | 0.00 | 80 | 80 | 0.0 | ⊚ | ⊚ |
| Ex. 2 | 12.0 | 12.0 | 0.0 | 0.04 | 0.04 | 0.00 | 80 | 80 | 0.0 | ⊚ | ⊚ |
| Ex. 3 | 15.0 | 15.0 | 0.0 | 0.03 | 0.03 | 0.00 | 80 | 80 | 0.0 | ⊚ | ⊚ |
| Ex. 4 | 12.0 | 12.0 | 0.0 | 0.04 | 0.04 | 0.00 | 80 | 80 | 0.0 | ⊚ | ⊚ |
| Ex. 5 | 12.0 | 11.0 | 8.3 | 0.04 | 1.86 | 1.86 | 80 | 86 | 7.5 | ◯ | ◯ |
| Comp. | 12.0 | 9.5 | 20.8 | 0.04 | 4.36 | 4.32 | 80 | 95 | 18.8 | X | X |
| Ex. 1 | | | | | | | | | | | |
| Comp. | 12.0 | 7.5 | 37.5 | 0.04 | 5.52 | 5.48 | 80 | 103 | 28.8 | X | X |
| Ex. 2 | | | | | | | | | | | |
| Comp. | 12.0 | 10.5 | 12.5 | 0.04 | 3.15 | 3.11 | 80 | 91 | 13.8 | X | X |
| Ex. 3 | | | | | | | | | | | |

T0: Thickness in the opening-portion-side standard region,
T1: Thickness in the opening-portion-side evaluation region,
ΔT: Thickness change ratio
Sa0: Arithmetical mean height in the opening-portion-side standard region,
Sa1: Arithmetical mean height in the opening-portion-side evaluation region,
ΔSa: Difference in arithmetical mean height
H0: Thickness in the non-opening-portion-side standard region,
H1: Thickness in the non-opening-portion-side evaluation region,
ΔH: Thickness change ratio

### Example 1

As shown in Table 1, a 15 μm-thick ONY (biaxially stretched nylon) film was laminated as a base layer 11 onto the outer surface of an 80 μm-thick aluminum foil used as the metal foil layer 12 via a two-part curing type polyester-urethane adhesive serving as a first adhesive layer. A 12 μm-thick PET (polyethylene terephthalate) film having an arithmetical mean height Sa of 0.04 μm was laminated onto the inner surface of the metal foil layer 12 as a heat-resistant gas barrier layer 13 via a two-part curing type polyester-urethane adhesive serving as a second adhesive layer. Furthermore, an 80 μm-thick CPP (non-stretched polypropylene) film was laminated onto the inner surface of the heat-resistant gas barrier layer 13 as a sealant layer 15 via a two-part curing type polyester-urethane adhesive serving as a third adhesive layer. At this time, the third adhesive layer was not applied to the opening-portion-intended portion. The size of this adhesive-free portion (opening-portion-intended portion) was 75 mm×120 mm.

The CPP is a three-layer co-extruded non-stretched polypropylene film, and the layer ratio of this three-layer co-extruded CPP film is: laminate layer (rPP: random polypropylene)/intermediate layer (bPP: block polypropylene)/seal layer (rPP: random polypropylene)=1.5/7/1.5.

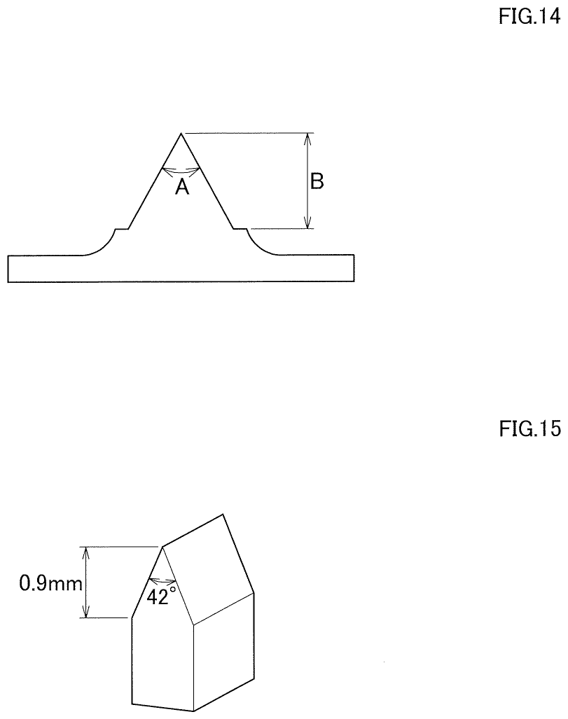

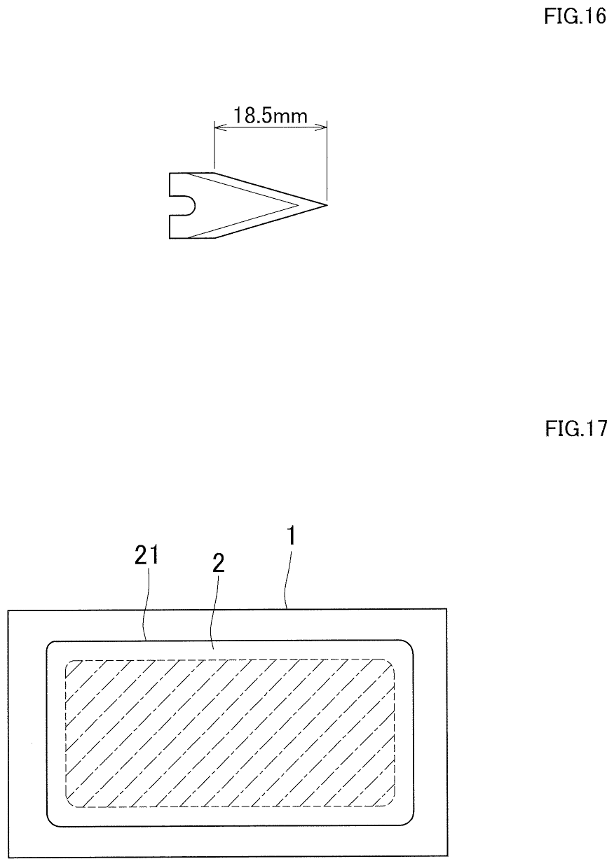

In the exterior material thus obtained, the sealant layer 15 in the opening-portion-intended portion (adhesive-free portion) was cut using a Pinnacle® blade, which is a punching blade, to form an opening portion 2. As shown in FIG. 14, a Pinnacle® blade having a blade angle A of 60° and a blade depth B of 0.3 mm was used.

In the exterior material having an opening portion of Example 1 obtained in this manner, as shown in Table 2, the thickness T0 and the arithmetical mean height Sa0 in the opening-portion-side standard region R0 of the heat-resistant gas barrier layer 13, and the thickness T1 and the arithmetical mean height Sa1 in the opening-portion-side evaluation region R1 were measured. Additionally, the thickness H0 in the non-opening-portion-side standard region Q0 and the thickness H1 in the non-opening-portion-side evaluation region Q1 of the sealant layer 15 were measured. Then, based on the thicknesses T0, T1, H0, and H1, and the arithmetical mean heights Sa0 and Sa1, the thickness change ratios ΔT and ΔH, and the difference ΔSa in arithmetical mean height were calculated using the above Expressions (1) to (3).

The opening-portion-side standard region R0, the opening-portion-side evaluation region R1, the non-opening-portion-side standard region Q0, and the non-opening-portion-side evaluation region Q1 were as described above (see FIG. 7).

The thicknesses T0 and H0 were measured at five arbitrary points in the regions R0 and Q0, respectively, using a microtome and a microscope, and the average values were used. Furthermore, the thickness T1 was measured at five arbitrary points in the opening-portion-side evaluation region R1 using a microtome and a microscope, and the minimum value was used. In addition, the thickness H1 was measured at five arbitrary points in the non-opening-portion-side evaluation region Q1 using a microtome and a microscope, and the maximum value was used.

The arithmetical mean heights Sa0 and Sa1 were measured by observing three arbitrary points on the surface of the opening-portion-side evaluation region R1 of the heat-resistant gas barrier layer 13 using a white light interferometer, in accordance with the method specified in ISO 25178. The average value of each was used.

It should be noted that the thicknesses T0 and H0 measured in Table 2 matched the original thicknesses of the heat-resistant gas barrier layer 13 and the sealant layer 15 shown in Table 1. Furthermore, the arithmetical mean height Sa0 measured in Table 2 matched the original arithmetical mean height of the heat-resistant gas barrier layer 13 shown in Table 1.

### Example 2

As shown in Tables 1 and 2, an exterior material having an opening portion was produced in the same manner as in Example 1, except that a Pinnacle® blade having a blade angle A of 40° was used. The change ratios ΔT and ΔH, and the difference ΔSa were calculated in the same manner.

### Example 3

As shown in Tables 1 and 2, an exterior material having an opening portion was produced in the same manner as in Example 2, except that ONY having a thickness of 15 μm and an arithmetical mean height Sa of 0.03 μm was used as the heat-resistant gas barrier layer. The change ratios ΔT and ΔH, and the difference ΔSa were calculated in the same manner.

### Example 4

As shown in Tables 1 and 2, an exterior material having an opening portion was produced in the same manner as in Example 1, except that a Thomson blade was used as the punching blade when forming the opening portion 2. The change ratios ΔT and ΔH, and the difference ΔSa were calculated in the same manner.

As shown in FIG. 15, the Thomson blade used in this example was made of high-tensile steel and had a blade angle of 42° and a blade depth of 0.9 mm.

### Example 5

As shown in Tables 1 and 2, an exterior material having an opening portion was produced in the same manner as in Example 1, except that a laser cutter was used when forming the opening portion 2. The change ratios ΔT and ΔH, and the difference ΔSa were calculated in the same manner.

The laser cutter used in this example was a CO2 laser cutter, with the output set to 30%.

### Comparative Examples 1 and 2

As shown in Tables 1 and 2, exterior materials with an opening portion were produced in the same manner as in Example 5, except that the output of the laser cutter was set to 40% and 50%, respectively. The change ratios ΔT and ΔH, and the difference ΔSa were calculated in the same manner.

### Comparative Example 3

As shown in Tables 1 and 2, an exterior material having an opening portion was produced in the same manner as in Example 1, except that the opening portion 2 was formed by cutting with an ultrasonic cutter. The change ratios ΔT and ΔH, and the difference ΔSa were calculated in the same manner.

As shown in FIG. 15, the ultrasonic cutter blade used in this Comparative Example was made of tool steel (vise steel), with a blade angle of 30° and a blade depth of 18.5 mm.

### Formability Evaluation

A 25-ton press machine manufactured by Amada Co., Ltd., equipped with a mold having a punch shape of 66 mm×110 mm, a punch corner R of 2 mm, a punch shoulder R of 1.3 mm, and a die shoulder R of 1 mm, was used.

On the other hand, for each Example and each Comparative Example, the exterior material 1 with an opening portion, i.e., the exterior material 1 with an opening portion 2 of 75 mm×120 mm (where the heat-resistant gas barrier layer was exposed), was cut into a rectangular shape of 135 mm in width and 180 mm in length, as shown in FIG. 17, to prepare forming test specimens for each Example and Comparative Example.

Then, using the above-mentioned press machine, deep drawing was performed on each forming test specimen such that the punch top surface contacted the opening portion 2 (the portion corresponding to the punch top surface is indicated with dashed hatching), thereby producing formed articles for each Example and Comparative Example.

The presence or absence of pinholes and cracks (fractures) at the corners of each molded article was checked using the transmitted light method in a darkroom, and the “maximum forming depth (mm)” at which no pinholes or cracks occurred was determined to evaluate the formability of the exterior material molded article.

The evaluation criteria are as follows, with ratings of ⊚ and ○ considered as passing. The results are shown together in Table 2.
⊚: No cracks or pinholes with a maximum forming depth of 5 mm or more
○: No cracks or pinholes with a maximum forming depth of 4.5 mm or more but less than 5 mm
x: Presence of cracks or pinholes, or both, with a maximum forming depth of less than 4.5 mm

### Measurement of Insulation Resistance (Insulation Property Evaluation)

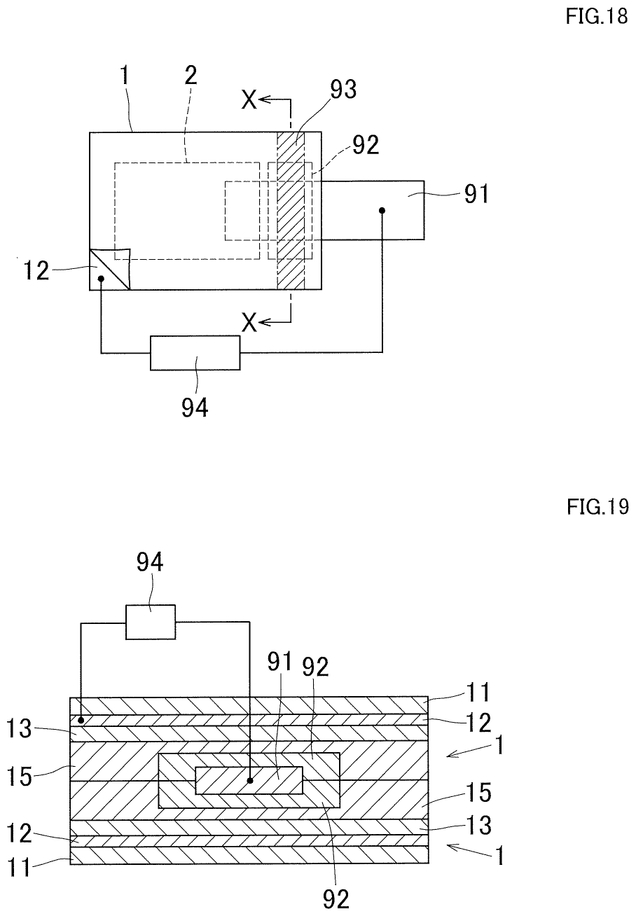

As shown in FIGS. 18 and 19, for each Example and each Comparative Example, two sheets of the exterior material having an opening portion 1 (with an opening portion size of 75 mm×120 mm) were cut out into a size of 135 mm in width and 180 mm in length, and a pair of specimens was prepared for each Example and Comparative Example.

A pair of insulation evaluation specimens 1 was stacked such that their respective sealant layers 15 faced and contacted each other. Meanwhile, a tab lead 91 made of aluminum foil with a width of 10 mm and a thickness of 100 μm was placed between the pair of specimens 1, with tab films 92 made of acid-modified polypropylene film with a thickness of 50 μm disposed on both sides of the tab lead. At this time, a portion of the tab lead 91 was placed between the pair of specimens 1, while the remaining portion was arranged to extend outward from the edge of the pair of specimens 1. The unbonded specimens were heat-fused by thermally bonding the sealant layers to each other using a double-sided heating-type heat sealer from both the top and bottom surfaces of the specimens 1, under the conditions of a sealing width of 5 mm, 200° C., and 0.3 MPa for 3 seconds, thereby obtaining the insulation evaluation specimen.

In the plan view of the insulation evaluation specimen shown in FIG. 18, hatching with diagonal lines is applied to the heat-bonded portion (heat seal portion) 93 to facilitate understanding of the present disclosure.

Subsequently, as shown in FIG. 18, at the longitudinal end of the insulation evaluation specimen, a portion of the resin used as the base layer 11 was peeled off to partially expose the aluminum foil serving as the metal foil layer 12, and electrical conduction to the aluminum foil (metal foil layer 12) from the outside was ensured at the exposed portion.

Then, one terminal of the insulation resistance measuring device (manufactured by HIOKI: model number “HIOKI 3154”) 94 was connected to the exposed portion of the metal foil layer 12 of the above insulation evaluation specimen, and the other terminal was brought into contact with the tab lead 91 to form a circuit. A voltage of 100 V was applied for 5 seconds between the metal foil layer 12 and the tab lead 91 in the circuit, and the resistance value measured was used as the insulation resistance value.

The evaluation criteria are as follows, with ratings of ⊚ (Excellent) and ○ (Pass) considered as acceptable. The results are shown together in Table 2.
⊚: Insulation resistance value of 200 MΩ or more
○: Insulation resistance value of 100 MΩ or more but less than 200 MΩ
x: Insulation resistance value of less than 100 MΩ

### Evaluation Results

As is clear from Table 2, the specimens of Examples 1 to 5 related to the present disclosure exhibited excellent formability and insulation properties. In contrast, the specimens of Comparative Examples 1 to 3, which deviate from the essential features of the present disclosure, were inferior in both formability and insulation properties.

The present application claims priority based on Japanese Patent Application No. 2023-19416 filed on Feb. 10, 2023, and the disclosure of that application is incorporated herein by reference in its entirety.

The terms and expressions used herein are employed for the purpose of explanation and are not intended to be interpreted in a limiting sense. It should be understood that the present disclosure is intended to cover all modifications, equivalents, and alternatives falling within the scope of the appended claims.

It should be understood that the terms and expressions used herein are used for explanation and have no intention to be used to construe in a limited manner, do not eliminate any equivalents of features shown and mentioned herein, and allow various modifications falling within the claimed scope of the present disclosure.

While the present disclosure may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the present disclosure may be embodied in many different forms, a number of illustrative embodiments have been described herein, the present disclosure is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

### INDUSTRIAL APPLICABILITY

The power storage device exterior material according to the present disclosure can be suitably used as a material for a battery case (casing) that houses an all-solid-state battery cell of an all-solid-state battery.

### DESCRIPTION OF REFERENCE SYMBOLS

1: Exterior material
11: Base layer
12: Metal foil layer
13: Heat-resistant gas barrier layer
15: Sealant layer
2: Opening portion
21: Edge portion
3: Case body
33: Flange
35: Housing portion
4: Sealing member
5: All-solid-state battery cell
H0: Thickness of non-opening-portion-side standard region of sealant layer
H1: Thickness of non-opening-portion-side evaluation region of sealant layer
ΔH: Thickness change ratio of sealant layer
Q0: Non-opening-portion-side standard region
Q1: Non-opening-portion-side evaluation region
R0: Opening-portion-side standard region
R1: Opening-portion-side evaluation region
Sa0: Arithmetical mean height of opening-portion-side standard region of heat-resistant gas barrier layer
Sa1: Arithmetical mean height of opening-portion-side evaluation region of heat-resistant gas barrier layer
ΔSa: Difference of arithmetical mean height of heat-resistant gas barrier layer
T0: Thickness of opening-portion-side standard region of heat-resistant gas barrier layer
T1: Thickness of opening-portion-side evaluation region of heat-resistant gas barrier layer
ΔT: Thickness change ratio of heat-resistant gas barrier layer

1. An exterior material having an opening portion for a power storage device, comprising:
a base layer made of resin;
a metal foil layer laminated on an inner surface side of the base layer;
a heat-resistant gas barrier layer made of resin and laminated on an inner surface side of the metal foil layer; and
a sealant layer made of resin and laminated on an inner surface side of the heat-resistant gas barrier layer,
wherein an opening portion is formed in the sealant layer to expose the heat-resistant gas barrier layer on an inner surface of the exterior material, and
wherein the exterior material is configured such that ΔT satisfies the following expression:
$$Δ T = ( \vert T 0 - T 1 \vert / T 0 ) \times 100 ≦ 10 \% ,$$
where
T0 is a thickness of the heat-resistant gas barrier layer in an opening-portion-side standard region, the opening-portion-side standard region being defined as a region extending from 1 mm to 1.5 mm toward the opening portion from an edge portion of the opening portion,
T1 is a thickness of the heat-resistant gas barrier layer in an opening-portion-side evaluation region, the opening-portion-side evaluation region being defined as a region extending from 0 mm to 0.5 mm toward the opening portion from the edge portion of the opening portion, and
ΔT is a thickness change ratio of the heat-resistant gas barrier layer in the opening-portion-side evaluation region, as defined by the above expression.

2. The exterior material having an opening portion for a power storage device, as recited in claim 1,
wherein the exterior material is configured such that ΔSa satisfies the following expression:
$$Δ Sa = \vert Sa 1 - Sa 0 \vert ≦ 2 μ m ,$$
where
Sa1 is an arithmetical mean height of the heat-resistant gas barrier layer in the opening-portion-side evaluation region,
Sa0 is an arithmetical mean height of the heat-resistant gas barrier layer in the opening-portion-side standard region, and
ΔSa is an absolute value of a difference between the arithmetical mean height of the heat-resistant gas barrier layer in the opening-portion-side evaluation region and the arithmetical mean height of the heat-resistant gas barrier layer in the opening-portion-side standard region, as defined by the above expression.

3. The exterior material having an opening portion for a power storage device, as recited in claim 1,
wherein the exterior material is configured such that ΔH satisfies the following expression:
$$Δ H = ( \vert H 0 - H 1 \vert / H 0 ) \times 100 ≦ 10 \% ,$$
where
H0 is a thickness of the sealant layer in a non-opening-portion-side standard region, the non-opening-portion-side standard region being defined as a region extending from 1 mm to 1.5 mm toward the non-opening portion from the edge portion of the opening portion,
H1 is a thickness of the sealant layer in a non-opening-portion-side evaluation region, the non-opening-portion-side evaluation region being defined as a region extending from 0 mm to 0.5 mm toward the non-opening portion from the edge portion of the opening portion, and
ΔH is a thickness change ratio of the sealant layer in the non-opening-portion-side evaluation region, as defined by the above expression.

4. The exterior material having an opening portion for a power storage device, as recited in claim 2,
wherein the exterior material is configured such that ΔH satisfies the following expression:
$$Δ H = ( \vert H 0 - H 1 \vert / H 0 ) \times 100 ≦ 10 \% ,$$
where
H0 is a thickness of the sealant layer in a non-opening-portion-side standard region, the non-opening-portion-side standard region being defined as a region extending from 1 mm to 1.5 mm toward the non-opening portion from the edge portion of the opening portion,
H1 is a thickness of the sealant layer in a non-opening-portion-side evaluation region, the non-opening-portion-side evaluation region being defined as a region extending from 0 mm to 0.5 mm toward the non-opening portion from the edge portion of the opening portion, and
ΔH is a thickness change ratio of the sealant layer in the non-opening-portion-side evaluation region, as defined by the above expression.

5. An exterior material having an opening portion for a power storage device, comprising:
a base layer made of resin;
a metal foil layer laminated on an inner surface side of the base layer;
a heat-resistant gas barrier layer made of resin and laminated on an inner surface side of the metal foil layer; and
a sealant layer made of resin and laminated on an inner surface side of the heat-resistant gas barrier layer,
wherein an opening portion is formed in the sealant layer material to expose the heat-resistant gas barrier layer on an inner surface of the exterior material, and
wherein the exterior material is configured such that ΔSa satisfies the following expression:
$$Δ Sa = \vert Sa 1 - Sa 0 \vert ≦ 2 μ m ,$$
where
Sa1 is an arithmetical mean height of the heat-resistant gas barrier layer in an opening-portion-side evaluation region, the opening-portion-side evaluation region being defined as a region extending from 0 mm to 0.5 mm toward the opening portion from an edge portion of the opening portion,
Sa0 is an arithmetical mean height of the heat-resistant gas barrier layer in an opening-portion-side standard region, the opening-portion-side standard region being defined as a region extending from 1 mm to 1.5 mm toward the opening portion from the edge portion of the opening portion, and
ΔSa is an absolute value of a difference between the arithmetical mean height of the heat-resistant gas barrier layer in the opening-portion-side evaluation region and the arithmetical mean height of the heat-resistant gas barrier layer in the opening-portion-side standard region, as defined by the above expression.

6. The exterior material having an opening portion for a power storage device, as recited in claim 5,
wherein the exterior material is configured such that ΔH satisfies the following expression:
$$Δ H = ( \vert H 0 - H 1 \vert / H 0 ) \times 100 ≦ 10 \% ,$$
where
H0 is a thickness of the sealant layer in a non-opening-portion-side standard region, the non-opening-portion-side standard region being defined as a region extending from 1 mm to 1.5 mm toward a non-opening portion from the edge portion of the opening portion,
H1 is a thickness of the sealant layer in a non-opening-portion-side evaluation region, the non-opening-portion-side evaluation region being defined as a region extending from 0 mm to 0.5 mm toward the non-opening portion from the edge portion of the opening portion, and
ΔH is a thickness change ratio of the sealant layer in the non-opening-portion-side evaluation region, as defined by the above expression.

7. An exterior material having an opening portion for a power storage device, comprising:
a base layer made of resin;
a metal foil layer laminated on an inner surface side of the base layer;
a heat-resistant gas barrier layer made of resin and laminated on an inner surface side of the metal foil layer; and
a sealant layer made of resin and laminated on an inner surface side of the heat-resistant gas barrier layer,
wherein an opening portion is provided in the sealant layer to expose the heat-resistant gas barrier layer on an inner surface of the exterior material,
wherein the exterior material is configured such that ΔH satisfies the following expression:
$$Δ H = ( \vert H 0 - H 1 \vert / H 0 ) \times 100 ≦ 10 \% ,$$
where
H0 is a thickness of the sealant layer in a non-opening-portion-side standard region, the non-opening-portion-side standard region being defined as a region extending from 1 mm to 1.5 mm toward a non-opening portion from an edge portion of the opening portion,
H1 is a thickness of the sealant layer in a non-opening-portion-side evaluation region, the non-opening-portion-side evaluation region being defined as a region extending from 0 mm to 0.5 mm toward the non-opening portion from the edge portion of the opening portion, and
ΔH is a thickness change ratio of the sealant layer in the non-opening-portion-side evaluation region, as defined by the above expression.

8. A power storage device case comprising:
a case body composed of the exterior material having an opening portion for a power storage device, as recited in claim 1,
wherein the case body includes a recessed housing portion and a flange provided around an outer periphery of the housing portion, and
wherein the opening portion is provided at a position corresponding to the housing portion.

9. A power storage device comprising:
the case body as recited in claim 8;
a power storage device cell housed in the housing portion of the case body; and
a sealing member heat-sealed to a flange of the case body while closing an opening of the housing portion of the case body.

10. The power storage device as recited in claim 9,
wherein the sealing member includes:
a base layer made of resin;
a metal foil layer laminated on an inner surface side of the base layer;
a heat-resistant gas barrier layer laminated on an inner surface side of the metal foil layer; and
a sealant layer laminated on an inner surface side of the heat-resistant gas barrier layer,
wherein the opening portion is provided in the sealant layer to expose the gas barrier layer of the sealing member to the housing portion.

11. A method for producing an exterior material having an opening portion for a power storage device, the exterior material including a base layer made of resin, a metal foil layer laminated on an inner surface side of the base layer, a heat-resistant gas barrier layer made of resin and laminated on an inner surface side of the metal foil layer, and a sealant layer made of resin and laminated on an inner surface side of the heat-resistant gas barrier layer,
the method comprising:
cutting an opening-portion-intended portion of the sealant layer with a punching blade to form the opening portion in the sealant layer to expose the heat-resistant gas barrier layer on an inner surface of the exterior material.
